(19) United States
(12) Patent Application Publication
(10) Pub. No.: US 2008/0170422 A1
(43) Pub. Date: Jul. 17, 2008

(54) Power on/off control architecture for power supply

(75) Inventors: Yung-Hsiang Shih, Taoyuan Hsien (TW); Kun-Feng Hsu, Taoyuan Hsien (TW)

Correspondence Address: Joe McKinney Muncy, PO Box 1364, Fairfax, VA, 22038-1364, US

(73) Assignee: SPI ELECTRONIC CO., LTD.

(21) Appl. No.: 11/652,689

(22) Filed: Jan. 12, 2007

(51) Int. Cl. H02M 7/02

(52) U.S. Cl. 363/84; 363/125

(57) ABSTRACT

The present invention provides a power on/off control architecture for a power supply so as to control the power on/off of the power supply. The power supply includes a rectifying unit, a standing power system, a PWM (Pulse Width Modulation) controller and a main power system. The standing power system controls whether the PWM controller can obtain the DC power required for operation, and in this power on/off control architecture for the power supply, a first power on/off unit is disposed in front of the DC power input port of the standing power system, so that the first power on/off unit can control the operation of the standing power system so as to further control the power on/off of the power supply.

### FIELD OF THE INVENTION

The present invention is related to a power on/off control architecture for a power supply, and more particularly to a switch architecture for controlling the conduction or disconnection of a DC power supplying loop required for a standing power system in the power supply.

### BACKGROUND OF THE INVENTION

Please refer to FIG. 1, which shows the circuit architecture of a conventional power supply. The power supply includes an EMI filter 1, a rectifying unit 2, a standing power system 3, a PWM (Pulse Width Modulation) controller 5, a PFC (Power Factor Correction) circuit 6, a main power system 7, a first power on/off unit 8, and a second power on/off unit 4. The EMI filter 1 is used to primarily filter the input AC current from an AC power input source 9 and the first power on/off unit 8 is located at the front end of the EMI filter 1 for controlling the conduction with the input port of the AC power input source 9. After the AC power is inputted from the first power on/off unit 8, passing through the EMI filter 1, to the rectifying unit 2, the rectifying unit 2 will primarily rectify the AC power for transforming into a DC power so as to supply to the standing power system 3, and then, the standing power system 3 provides a standing power to the system. After the second power on/off unit 4 is triggered, it will command the PWM controller 5 to work so as to generate a duty cycle required for operating the PFC circuit 6 and the main power system 7. However, in the conventional architecture, since the higher the output power of the power supply, the more the required current, the current bearing capability of the first power on/off unit 8 at the AC power input port must be significantly raised. But, since the space in the power supply is limited, it is difficult to extend the first power on/off unit 8, and further, the current intensity of the first power on/off unit 8 also has to conform to the safety regulations, so that the architecture of the first power on/off unit 8 is a barrier for achieving the power supply with high power.

### SUMMARY OF THE INVENTION

Therefore, the object of the present invention is to provide a power on/off control architecture, through which the current passing through the first power on/off unit can be reduced so that the element having a relatively lower current bearing capability can be employed by the first power on/off unit to control the power supply.

The present invention provides a power on/off control architecture for a power supply including a rectifying unit, a standing power system, a PWM (Pulse Width Modulation) controller and a main power system controlled by the PWM controller, wherein the operation of the PWM controller is determined by the operation of the standing power system. Furthermore, a first power on/off unit is disposed on the DC power loop, which drives the standing power system, so that the first power on/off unit can control the conduction or disconnection of the loop, and through controlling the power source of the standing power system, the operation of, at the back end, a second power on/off unit and the PWM are also controllable, result in that the power on/off of the power supply can be controlled by the first power on/off unit. Since the power required by the standing power system is rectified by the rectifying unit and partially outputted to the standing power system, and the output power of the standing power system is smaller than that of the main power system, the current required by the standing power system is relatively lower, namely, the current passing through the standing power system is smaller, so that a first power on/off unit with smaller volume and lower cost can achieve the purpose as the conventional ones.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a block diagram showing the conventional power supply;

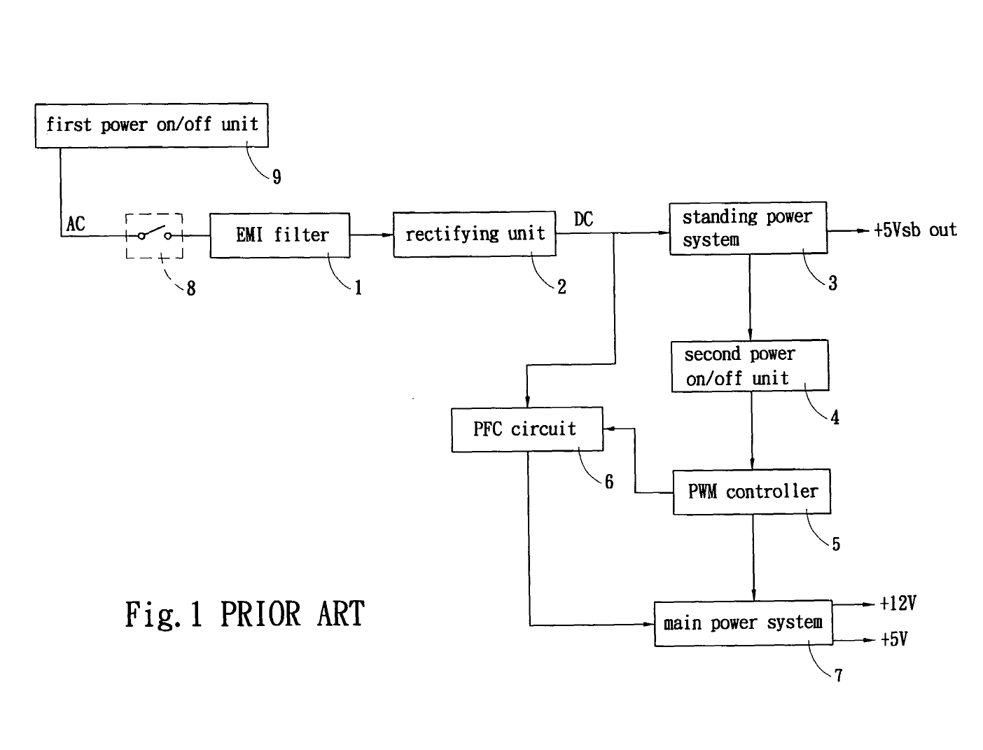

FIG. 2 is a block diagram showing the power on/off control architecture according to the present invention; and

FIG. 3 is a three-dimensional diagram showing a computer adopting the power supply according to the present invention.

### DESCRIPTION OF THE PREFERRED EMBODIMENT

The present invention provides a power on/off control architecture for a power supply, including an AC power input source 9, a rectifying unit 2, a standing power system 3 and a main power system 7. The rectifying unit 2 is connected to the AC power input source 9 for rectifying and then outputting a DC power, and the DC power will drive the standing power system 3 and also the main power system 7, which is located at the output end of the rectifying unit 2 and connected with the standing power system 3 in parallel. Furthermore, a first power on/off unit 8 is disposed on the DC power loop, which drives the standing power system 3, so that when the first power on/off unit 8 is in a short state, the standing power system 3 can obtain the DC power so as to drive a second power on/off unit 4, and then, the second power on/off unit 4 can produce a power on/off signal to control whether the main power system 7 can obtain the DC power for operation.

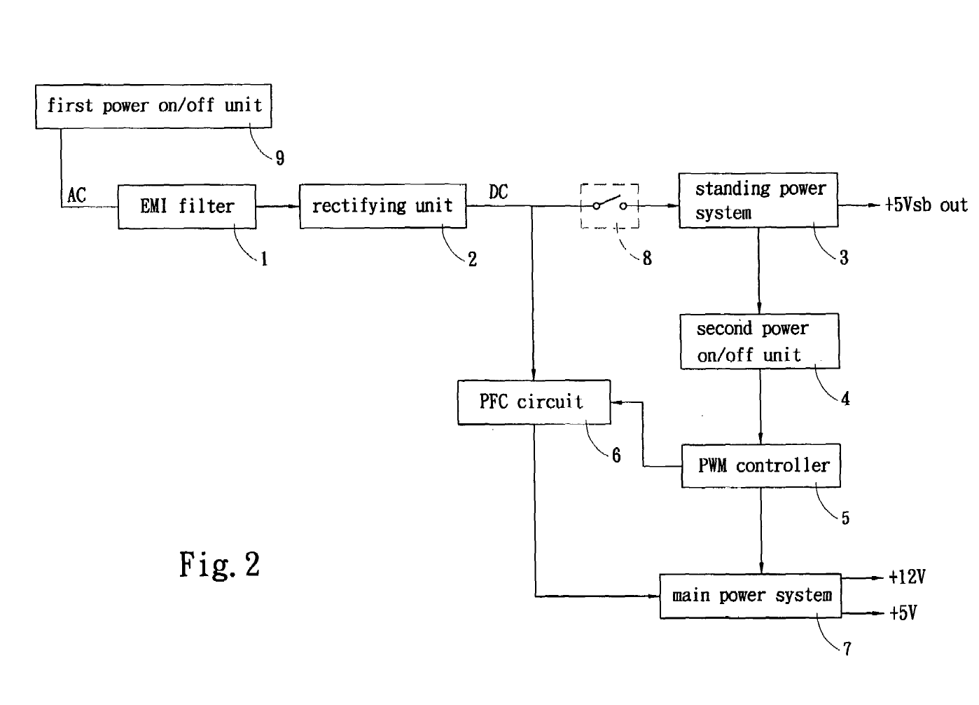

Please refer to FIG. 2, which shows a block diagram for the present invention. The power supply includes a rectifying unit 2, a standing power system 3, a PWM (Pulse Width Modulation) controller 5, a main power system 7, a first power on/off unit 8, and a second power on/off unit 4. Moreover, the power supply can further include an EMI filter 1 and a PFC (Power Factor Correction) circuit 6. The rectifying unit 2 is connected to the AC power input source 9 through the EMI filter 1, so that the AC input power can be transformed into the DC power and then outputted to the standing power system 3 and the main power system 7, which are connected in parallel. In the present invention, a first power on/off unit 8 is disposed on the DC power loop, which drives the standing power system 3, so that when the first power on/off unit 8 can control the conduction or disconnection of the DC power loop. When the first power on/off unit 8 is conducted, the standing power system 3 can obtain the DC power and output a standing DC power, so that the second power on/off unit 4 is driven to command the PWM controller 5 to produce a cycle signal required by the PFC circuit 6 and the main power system 7, so as to make the main power system 7 normally output the power. When the first power on/off unit 8 is disconnected, the standing power system 3 can not operate and also the second power on/off unit 4 and the PWM controller 5 at back end, so that the main power system 7 can not generate the output. Therefore, since, in the present invention, the first power on/off unit 8 is disposed on the DC power loop of the standing power system 3 for controlling the operation of the power supply, the DC power inputted into the standing power system 3 is smaller than the AC power inputted at the AC power input port, and thus, the first power on/off unit 8 can employ the element having a relatively lower current bearing capability according to the intensity of the DC power.

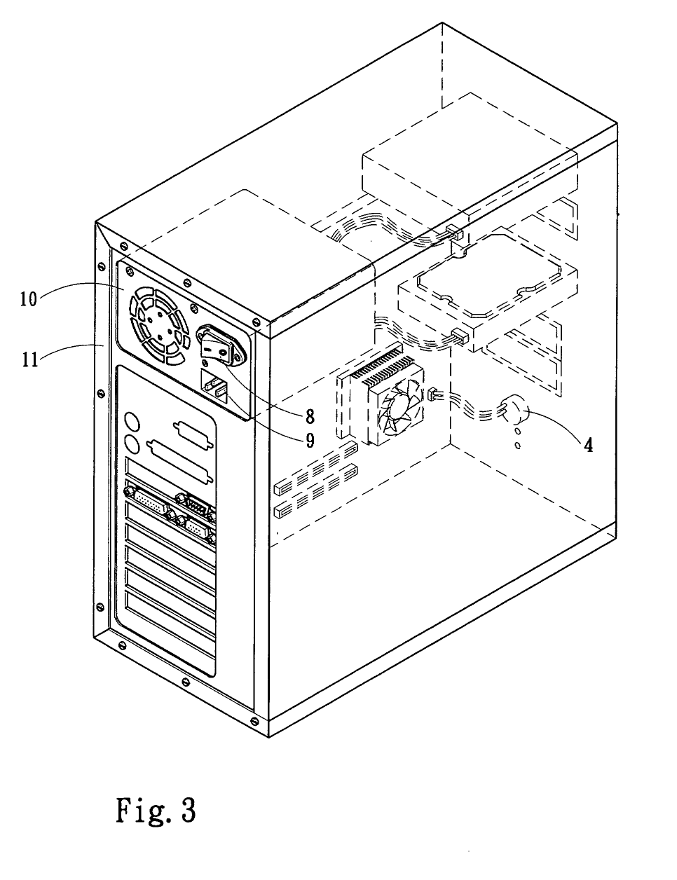

Please refer to FIG. 3 which shows the appearance of a computer adopting the present invention. In this computer, a power supply 10 is mounted at the upper back end of the case 11, and on the panel of the power supply 10, the first power on/off unit 8 and the AC power input source 9 are mounted, and further, the second power on/off unit 4 is mounted on the front panel of the computer and supplied by the standing power system 3. According to the conventional architecture, the first power on/off unit 8 controls the conduction of the AC power source so as to control the operation of the power supply 10. However, in the present invention, the first power on/off unit 8 is used to control the DC power required by the standing power system 3 in the power supply 10, thereby controlling the standing power of the power supply 10. Consequently, according to the present invention, the intensity of the current passing through the first power on/off unit 8 can be reduced, and thus, the first power on/off unit 8 can be selected to have a smaller volume and a lower cost, and also, the problems of space design and safety regulations are simultaneously solved.

The advantages of the present invention are:

1. The volume of the first power on/off unit is reduced so that the space inside the power supply can be saved.

2. The cost of the first power on/off unit is reduced.

3. The current intensity of the first power on/off unit conforms to the safety regulations.

Although the present invention is disclosed by the preferred embodiments described above, the present invention is not limited thereto, for example, the rectifying unit 2 can be replaced by a bridge rectifier or a rectifying circuit capable of switching between AC and DC currents. Those skilled in the art will appreciate that various modifications, additions and substitutions are possible, without departing from the scope and spirit of the invention as disclosed in the accompanying claims.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A power on/off control architecture for a power supply, comprising:
an AC power input source;
a rectifying unit, connected to the AC power input source for rectifying and then outputting a DC power; and
a standing power system, driven by the DC power, and a main power system, connected with the standing power system in parallel and also driven by the DC power,
wherein a first power on/off unit is disposed on the DC power loop, which drives the standing power system, so that when the first power on/off unit is in a short state, the standing power system obtains the DC power so as to drive a second power on/off unit, and then, the second power on/off unit produces a power on/off signal to control whether the main power system obtains the DC power for operation.

2. The architecture as claimed in claim 1, wherein the rectifying unit is a bridge rectifier.

3. The architecture as claimed in claim 1, wherein the power required for operating the second power on/off unit is provided by the standing power system.

4. The architecture as claimed in claim 1, wherein the power supply further comprises a pulse width modulation controller to provide a duty cycle for the main power system and a power factor correction circuit to rectify a duty efficiency of the main power system.

5. The architecture as claimed in claim 3, wherein the pulse width modulation controller is started to operate through triggering the second power on/off unit.

6. The architecture as claimed in claim 4, wherein the pulse width modulation controller produces the duty cycle for the main power system.

7. The architecture as claimed in claim 4, wherein the power factor correction circuit is driven by receiving the duty cycle produced by the pulse width modulation controller.
